(19) United States
(12) Patent Application Publication
(10) Pub. No.: US 2017/0163417 A1
(43) Pub. Date: Jun. 8, 2017

(54) APPARATUS AND METHOD FOR KEY PROVISIONING

(71) Applicant: QUALCOMM Incorporated, San Diego, CA (US)

(72) Inventors: Ivan McLean, San Diego, CA (US); David Tamagno, Livermore, CA (US); Stuart Moskovics, San Diego, CA (US); Manfred Von Willich, San Diego, CA (US)

(21) Appl. No.: 15/040,890

(22) Filed: Feb. 10, 2016

Related U.S. Application Data
(60) Provisional application No. 62/264,813, filed on Dec. 8, 2015.

(51) Int. Cl. H04L 9/08; H04L 9/30; H04W 12/04; H04L 29/06; H04W 12/06; H04L 9/14; H04L 9/32

(52) U.S. Cl. CPC H04L 9/0877; H04L 9/14; H04L 9/3066; H04L 9/3234; H04L 63/0853; H04W 12/06; H04L 63/062; H04W 12/04; H04L 2209/80

(57) ABSTRACT

Aspects may relate to a device that comprises: a non-volatile storage medium (NVM) to store a signature and a device key, the device key based on a symmetric master key and an identifier; an interface; and a processor coupled to the interface and the NVM. The processor may be configured to: apply a key derivation function (KDF) to the device key to generate a derivative key; apply a key generation function to the derivative key to generate at least one public key; and command transmission of the signature and the at least one public key through the interface to a service provider.

### CROSS REFERENCE TO RELATED APPLICATIONS

The present application claims priority to U.S. Provisional Patent Application No. 62/264,813, filed Dec. 8th, 2015, entitled “Apparatus and Method for Key Provisioning,” the content of which is hereby incorporated by reference in its entirety for all purposes.

### FIELD

The present invention relates to an apparatus and method for key provisioning.

### RELEVANT BACKGROUND

The provisioning and storage of unique keying material on chip designs for computing devices is fundamental to the subsequent bootstrapping of the security for each chip. The initial key material provisioned very early during the chip life cycle is used to uniquely identify and authenticate the commercial computing device containing the chip, to attest to the configuration and the security posture of the device, and to provision that device with additional secret key material, sensitive information, and configuration data.

Key material that is to be provisioned during chip manufacture, such as, system-on-chip (SoC) manufacture, may ideally be public key based. In this context, public keys have a number of significant benefits over symmetric keys. In particular, a significant benefit is that by utilizing public keys, backend infrastructure does not need to generate, transport, store, and update large databases of sensitive symmetric device key material. This dramatically simplifies the overhead involved in deploying and operating backend infrastructure and also removes risks associated with massive exposure of the client device population by leakage of those device unique symmetric keys. In addition, it is beneficial to have primordial public keys held by the computing device itself to be certified. Traditionally, this is accomplished by signing the public keys and having the device store and later present the device-unique public key and signature (or certificate) to the service infrastructure. This approach removes the need to maintain synchronized per-device records of all certified public keys.

Many traditional approaches to address security issues have been attempted by a combination of one or more of the following techniques: provisioning and storing full-blown key pairs and certificates/signatures during chip manufacture and accepting the great amount of fuse area overhead and test time costs that this incurs; provisioning small device-unique symmetric keys, which are then tracked and managed in the backend infrastructure, where they may be subject to compromise; provisioning public key pairs without the corresponding signature over these keys and maintaining a database of per-devise public keys and associated device identifiers that must be tracked via the backend infrastructure; deferring provisioning to later in the chip-device life cycle, such as, by the original equipment manufacturer (OEM), which is very problematic in that the security of the keys is left to the OEM, and the OEM may be unwilling or unable to support sufficient security levels.

It should be appreciated that all of these traditional approaches are problematic for chip vendors, where keys are associated with chips before the manufacture of the containing computing device. For example, non-volatile memory (NVM) is generally an extremely scarce and expensive resource on chip designs. In particular, fuse-based non-volatile storage medium is generally considered to be very expensive in terms of area costs. Further, it is often overlooked that the corresponding programming time overhead during manufacture may many times outweigh the other associated costs of storing the large amounts of data in fuses of the NVM.

Thus, as previously described, there are many constraints that make the provisioning and storage of large public keys or certificates prohibitive, and force vendors into less-optimal solutions.

### SUMMARY

Aspects may relate to a device that comprises: a non-volatile storage medium (NVM) to store a signature and a device key, the device key based on a symmetric master key and an identifier; an interface; and a processor coupled to the interface and the NVM. The processor may be configured to: apply a key derivation function (KDF) to the device key to generate a derivative key; apply a key generation function to the derivative key to generate at least one public key; and command transmission of the signature and the at least one public key through the interface to a service provider.

### BRIEF DESCRIPTION OF THE DRAWINGS

FIG. 1 is a diagram of a system in which embodiments may be practiced.

FIG. 2A is a diagram illustrating generating device IDs and signatures.

FIG. 2B is a diagram illustrating utilizing an elliptic curve function to generate signatures.

FIG. 3 is a diagram illustrating a computing device establishing a secure communication channel with a service provider.

FIG. 4 is flow diagram illustrating a process implemented by a computing device.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, “system-on-chip (SoC)”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

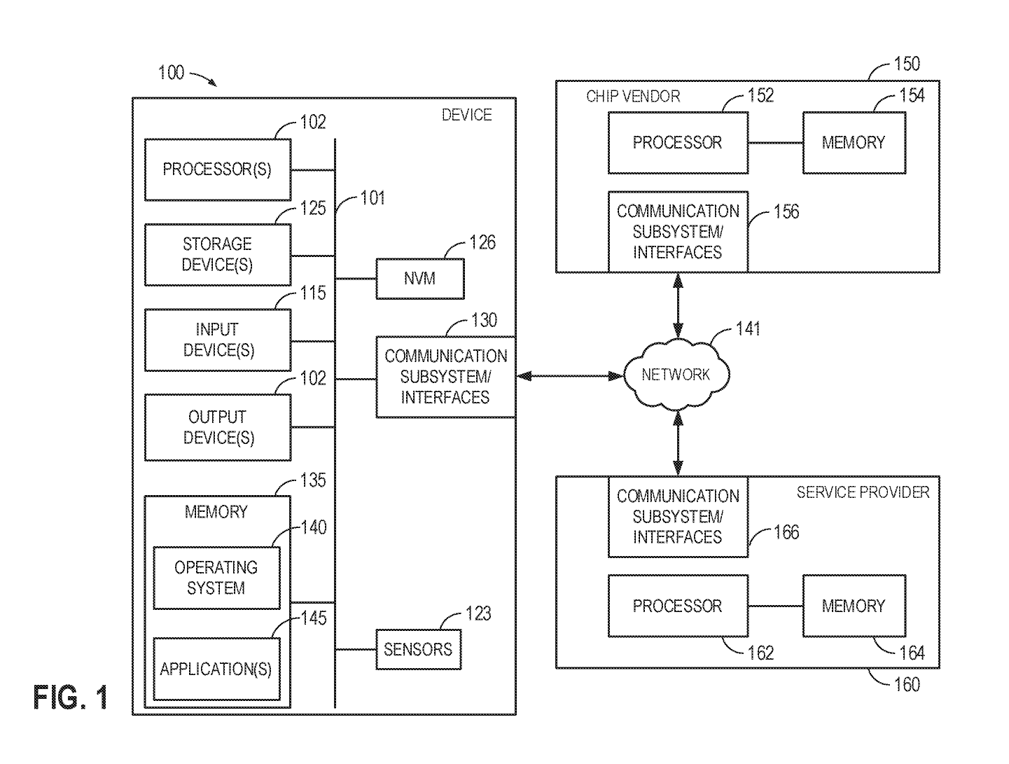

With reference to FIG. 1, an example computing device 100 may be in communication with a plurality of other entities having computing devices 150 and 160, respectively, via a network 141. As will be described in more detail hereafter, as an example, computing device 150 may be operated by a chip vendor that utilizes a computing device in chip manufacturing (e.g., SoCs) and computing device 160 may be a service provider 160 that provides services based on data exchanges with computing device 100 through the network 141.

As an example, computing device 100 may comprise hardware elements that can be electrically coupled via a bus 101 (or may otherwise be in communication, as appropriate). The hardware elements may include one or more processors 102, including without limitation one or more general-purpose processors and/or one or more special-purpose processors (such as digital signal processing chips, graphics acceleration processors, and/or the like); one or more input devices 115 (e.g., keyboard, keypad, touchscreen, mouse, etc.); and one or more output devices 122 (e.g., display device, speaker, printer, etc.). Additionally, computing device 100 may include a wide variety of sensors 123. Sensors may include: a clock, an ambient light sensor (ALS), a biometric sensor (e.g., blood pressure monitor, etc.), an accelerometer, a gyroscope, a magnetometer, an orientation sensor, a fingerprint sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone, a camera, or any type of sensor.

Computing device 100 may further include (and/or be in communication with) one or more non-transitory storage devices or non-transitory memories (NVM) 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Additionally, in one embodiment, computing device 100 may include a particular type of non-volatile storage medium (NVM) 126 to store IDs, signatures, and devices keys, as will be described in more detail hereafter. Any type of NVM may be utilized. In some embodiments, the NVM 126 may include fuse-based one time programmable (OTP) memory. However, any type of NVM may be utilized such as ROM, on-chip flash, fuse-based memory, anti-fuse based memory, etc., to support the functions to be hereafter described.

Computing device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communications subsystems and/or interfaces 130 may permit data to be exchanged with other computing devices 150, 160 (e.g., chip vendors, service providers, etc.) through an appropriate network 141 (wireless and/or wired), as will be hereafter described.

In some embodiments, computing device 100 may further comprise a working memory 135, which can include a RAM or ROM device, as described above. Computing device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a computing device 100 to perform one or more operations in accordance with the described methods, according to embodiments described herein.

A set of these instructions and/or code may be stored on a non-transitory computer-readable storage medium, such as the storage device(s) 125 described above. In some cases, the storage medium might be incorporated within a computer system, such as computing device 100. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by computing device 100 and/or might take the form of source and/or installable code, which, upon compilation and/or installation on computing device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

As previously described, computing device 100 may be any type of device, computer, smartphone, system-on-chip (SoC), tablet, cellular telephone, watch, wearable device, Internet of Things (IoT) device, etc.

As has been previously described, computing device 100 may be in communication via interface 130 through network 140 to chip vendor 150 and service provider 160, as will be described in more detail hereafter. It should be appreciated that chip vendor 150 may include a computing device having at least a processor 152, a memory 154, and an interface/communication subsystem 156 that may operate as computer system, similar to that of previously described computing device 100, to implement operations to be hereinafter described in more detail. Similarly, service provider 160 may include a computing device having at least a processor 162, a memory 164, and an interface/communication subsystem 166 that may operate as computer system, similar to that of previously described computing device 100, to implement operations to be hereinafter described in more detail. It should be appreciated that computing device 100, chip vendor 150, and service provider 160 may be in communication through network 141 in a wireless, wired, or combination of wireless/wired fashion.

In one embodiment, computing device 100 may include a non-volatile storage medium (NVM) 126 to store a signature and a device key, the device key based on a symmetric master key and an identifier; an interface 130; and a processor 102 coupled to the interface 130 and the NVM 126. The processor 102 may be configured to: apply a key derivation function (KDF) to the device key to generate a derivative key; apply a key generation function to the derivative key to generate at least one public key; and command transmission of the signature and the at least one public key through the interface 130 through network 141 to service provider 160 such that service provider 160 is capable of verifying the computing device 100 and establishing a secure communication channel through network 141 with computing device 100. As will be described, the key generation function to generate the at least one public key may include the use of an elliptic curve function. Further, in one embodiment, the at least one public key may include a pair of public keys that are generated by the elliptic curve function that may include an authentication public key and encryption public key that are unique to the computing device 100. In one embodiment, computing device 100 may command a transmission of the signature and the pair of public keys (e.g., the authentication public key and the encryption public key) through wireless interface 130 and network 141 to service provider 160 that receives this data via wireless interface 166. In this way, service provider 160, under the control of processor 162 and in conjunction with memory 164, may verify computing device 100 and establish a secure communication channel through network 141 with computing device 100 for secure communication purposes.

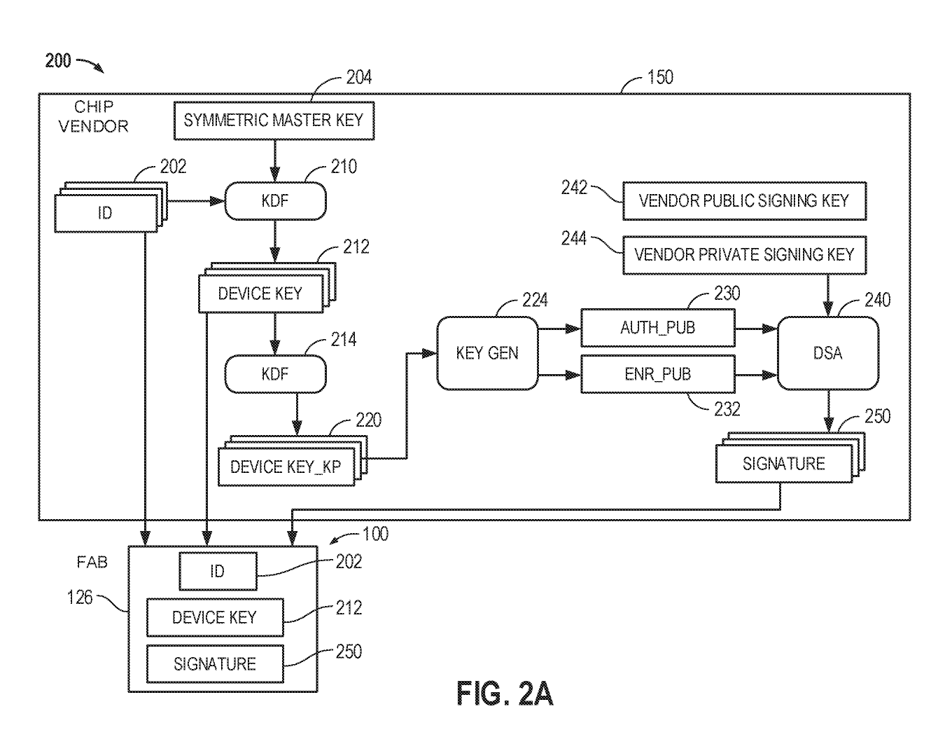

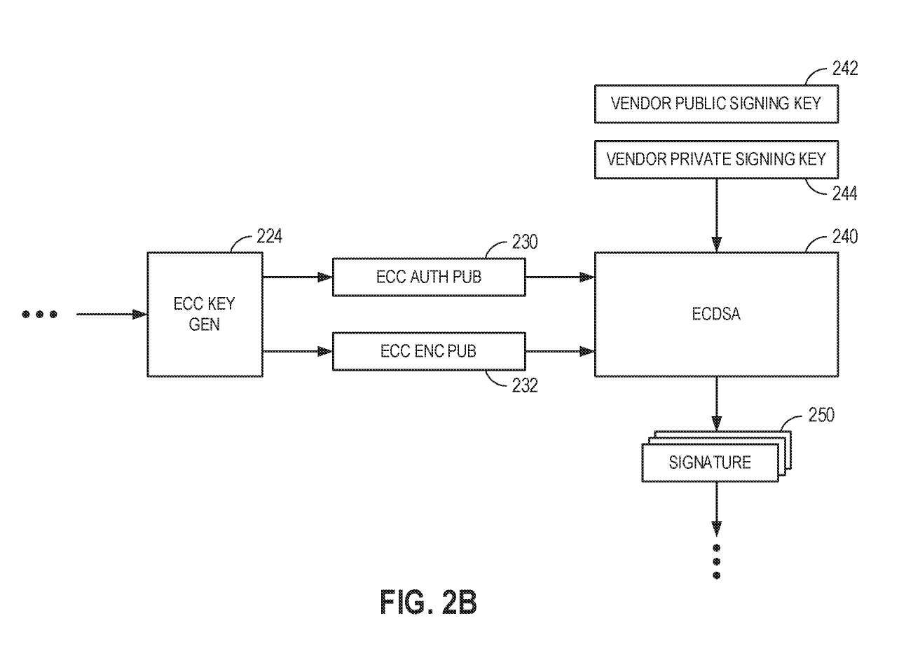

With additional reference to FIG. 2A, chip vendor 150 may define IDs 202, device keys 212 and signatures 250 for chip sets for computing devices 100. It should be appreciated that the chip vendor 150 may utilize an appropriate computing device including at least a processor 152 in conjunction with a memory 154 to implement the hereafter described functionality and an interface 156 for communication with a fabrication facility, as well as, a service provider. However, any suitable means of functional implementation and communication may be utilized.

As an example, chip vendor 150 may create a symmetric master key 204 that is used to generate all subsequent device keys 212 and signatures 250 for each chip of a computing device 100 to be manufactured by a chip fabricator. As has been previously described, each computing device 100 may include a chip (e.g. a system-on-chip) SOC)) having a non-volatile storage medium (NVM) 126 that stores an ID 202, a device key 212, and signature 250, all of which are unique to that device. As an example, the NVM 126 may be a fuse-based one time programmable (OTP) memory. Although any suitable type of NVM 126 may be utilized.

Looking at particular example operations 200 performed by the chip vendor 150, a symmetric master key 204 generated by the chip vendor in conjunction with a designated unique identifier (ID) 202 for the chip may be fed into a key derivation function (KDF) 210. The resulting key is the device key 212 unique for the particular chip of the device. The device key 212 may be stored in the NVM 126 of the chip under manufacture by the fabrication facility along with the ID 202 of the chip of the device under manufacture. It should be noted that in order to create the signature 250 for the device, the device key 212 is not used directly. Instead, a further derivative key is created by passing the device key 212 into another KDF 214 to create a derivative device key 220 (denoted as Device Key KP). Also, in one embodiment, the device key process through KDF 214 may also be processed in conjunction with hard coded context data.

The resulting derivative key 220 may then be used for a key provisioning process to be hereafter described. In one embodiment, the derivative key 220 may be used to AES-encrypt two predefined hard coded values/numbers. The actual values for these hard coded values are not of great significance, as long as they differ. The resulting pair of ciphertext values may be used as seeds to feed to a key generation function 224.

In one embodiment, the key generation function 224 may be utilized to generate at least one public key. For example, key generation function 224 may generate a public key pair including an authentication public key 230 and an encryption public key 232 that are utilized as inputs to a digital signal algorithm 240 that is used to generate a unique signature 250 for the chip of the device 100 that is stored in the NVM 126. It should be appreciated that although it has been previously described that an ID 202, a device key 212, and a signature 250 can be created that are unique to that particular device that, in other embodiments, in similar fashion, an ID, device key, and/or signature may be generated for a group of devices.

With brief additional reference to FIG. 2B, in one embodiment, the key generation function 224 may include an elliptic curve function (ECC) to generate the pair of public keys, which are ECC derived (e.g., ECC authentication public key 230 and ECC encryption public key 232). Further, the digital signal algorithm 240 may be an elliptic curve based digital signal algorithm (e.g., ECDSA 240) to generate the signatures 250. It should be appreciated that any type of suitable key generation algorithm 224 and digital signal algorithm 240 may be utilized. However, the previously described, referenced ECC types will be hereafter described, as one example.

As previously described, derivative key 220 may be fed to the ECC key generator 224. Additionally, derivative key 220 may be used to AES-encrypt two predefined hard coded values/numbers. The actual values of these hard coded values are not of great significance, as long as they differ. The resulting pair of ciphertext values may be used as seeds to feed to the ECC key generation function 224 in conjunction with the derivative key 220 itself. In one embodiment, the ECC key generation function 224 may be run twice, using each of the seed values. By utilizing this operation, two device-unique ECC key-pairs (ECC authentication public key 230 and ECC encryption public key 232) are generated. One of these key-pairs may be reserved for purposes of encryption and the other for authentication purposes.

In one embodiment, prior to performing any of these operations, the chip vendor 150 may create a root key pair that is used for signing each pair of the device-unique public keys through the ECDSA 240. The public key may be denoted vendor public signing key 242. The private key used for signing may be denoted as vendor private signing key 244 that is fed to ECDSA 240. Thus, chip vendor 150 may utilize the private signing key 244 to create an ECDSA 240 signature 250 for each set of device-unique public keys 230 and 232.

In conclusion of the process implemented by the chip vendor 150, the device ID 202, the device key 212, and the signature 250 may be transmitted/shipped/etc. to the chip fabrication facility, where they are provisioned to the NVM 126 of the chip of the device under manufacture during the manufacturing process. It should be appreciated that, as previously described, this may be utilized for any type of chip for any type of computing device under manufacture.

It should be appreciated that the previously described process implemented by chip vendor 150 allows for extremely efficient provisioning and personalization of the virgin chip to store an ID 202, a device key 212, and a signature 250 to the NVM 126 of a chip of a device. In particular, the previously described process provides the capability to provision primordial key material in a manner that is extremely efficient and low cost in terms of area/fuse overhead and tester time. This is especially true in the instance that the NVM 126 is a fused-based one time programmable (OTP) memory. Further, it should be noted that the key-pairs themselves are not distributed or provisioned. This approach allows for significant savings in NVM 126 storage without any compromise of security or functionality by only provisioning the three values previously described (e.g., ID 202, device key 212, and signature 250). As a particular example, the resulting OTP requirement is only 672 bits- assuming a 32-bit device ID 202, a 128-bit device key 212, and a 512-bit ECDSA signature 250. Further, is should be noted that more fused/storage savings may occur vs. traditional approaches by utilizing short signature schemes. Moreover, after the computing device 100 is commercially deployed, the provisioned key material is leveraged as will be particularly described. It should be noted that for IoT devices or other types of devices utilizing a SoC with relatively low OTP fuse storage space these techniques are especially beneficial.

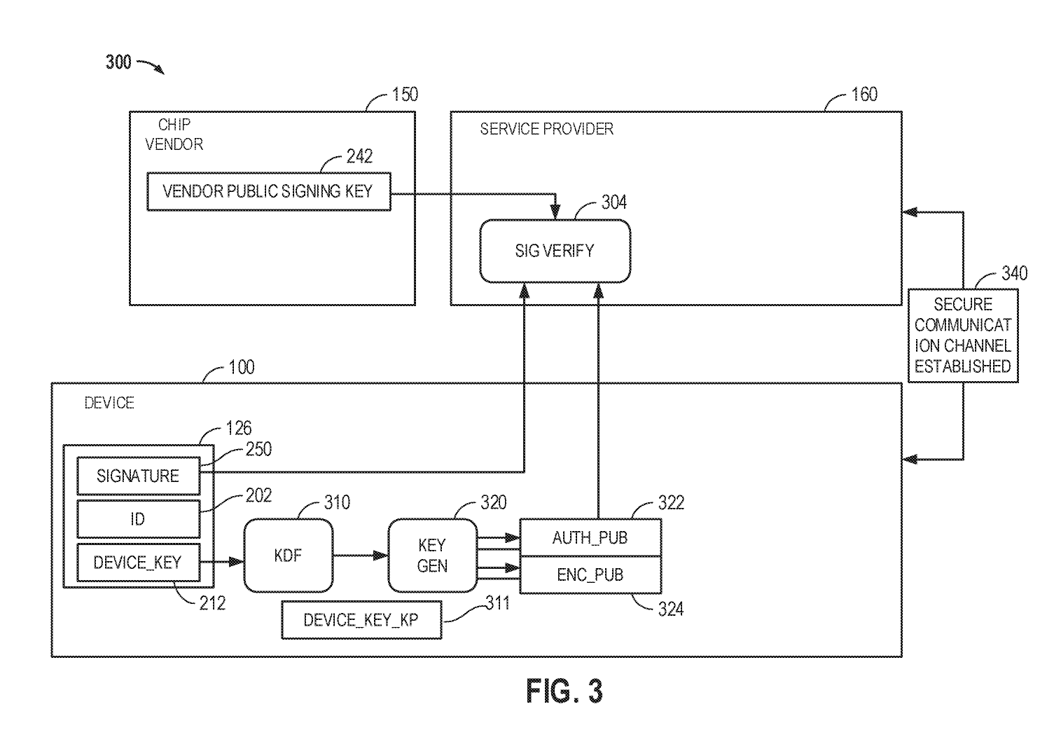

With additional reference to FIG. 3, a diagram is shown illustrating computing device 100 establishing a secure communication with a service provider 160. As has been previously described, in some embodiments, computing device 100 under the control of processor 102, in conjunction with memory 135 and utilizing interface 130, may implement the functions to be hereafter described to generate at least one public key, e.g., a pair of public keys, and to transmit the pair of public keys and a signature 250 to service provider 160 such that service provider 160 is capable of verifying the computing device 100 to establish a secure communication channel allowing for the transmission and receipt of data.

It should be appreciated that many of the operations of computing device 100 essentially mirror many of the same functions performed by chip vendor 150 during the provisioning phase. In one embodiment, the device key 212 stored in NVM 126 is fed into a KDF 310. KDF 310 is applied to the device key 212 to generate a derivative key 311 (denoted as Device Key KP). In this way, a specific dedicated derivative key 311 to be used for key provisioning purposes is generated. The derivative key 311 in turn may be used to AES-encrypt two predefined hard coded numbers/values. The resulting ciphertext values may be used as seeds to feed a key generation function 320. The key generation function 320 may be run twice using each of the seed values. This results in the generation of two device-unique key pairs 322 and 324. This key pair includes an authentication public key 322 and an encryption public key 324. In one embodiment, the key generation function 320 may be an elliptic curve (ECC) key generation function and the two device-unique key pairs 322 and 324 generated may be ECC key pairs (e.g., an ECC authentication public key 322 and ECC encryption public key 324). It should be noted, as previously described, that any sort of key generation function may be utilized and that the utilization of an elliptic curve function is just one example of a key generation function to generate public keys and that any suitable type of key generation function may be utilized.

After the generation of the pair of public keys, computing device 100 may then transmit the signature 250 and the pair of public keys (e.g., authentication public key 322 and encryption public key 344) through interface 130 through network 140 to service provider 160 to verify itself to the service provider 160 such that a secure communication channel 340 can be established. For example, this may be accomplished through a wireless network.

As previously described, service provider 160 under the control of processor 162, and via the receipt of data via interface 166 through the network 141, may utilize the received signature 250 to verify the public keys 322 and 324 received from computing device 100. As one example, service provider 160 may apply a signature verification function 304 to verify the public keys 322 and 324 by the signature 250. It should be appreciated that service provider 160 implementing the signature verification process 304 may utilize the vendor public signing key 242 received from the chip vendor 150 in order to verify the public keys 322 and 324 based upon the signature 250. If the signature verification function 304 of service provider 160 verifies the public keys 322 and 324 in view of the signature 250 as being authenticated, then service provider 160 may establish a secure communication channel 340 such that computing device 100 is authenticated and data/assets may be securely delivered to computing device 100.

Once the signature verification function 304 of service provider 160 has verified the public keys 322 and 324 based upon the signature 250, such that computing device 100 is authenticated, data/assets may be securely delivered via the secure communication channel 340 to computing device 100. It should be appreciated that a pair of public keys including an authentication public key and an encryption public key have been described as being utilized for verification, as an example, but it should be appreciated that a single public key generated by key generator 320 may be used instead of a pair of public keys, to accomplish these functions. Also it should be appreciated that other public key cryptographic algorithms, such as RSA may be used.

There are a multitude of difference examples of the type of data/assets that may be securely delivered to computing device 100 after verification and authentication. For example, service provider 160 may be an on-line bank to allow for monetary transactions, an on-line store to allow for the purchase of goods and/or services, or a power company to allow for the payment of energy usage, or a medical company to receive medical data, etc. Thus, service provider 160 may be any type of data, information, asset provider for use by a computing device 100, after verification of the computing device. As one particular example, computing device 100 may be an IoT device utilizing a SoC with a relatively small NVM storage space (e.g., a fuse-based OTP memory) such as a thermostat, smart light, etc.

Thus, the embodiments previously described provide the capability to provision primordial key material in a manner that is extremely efficient and low-cost in terms of area/fuse overhead in NVM and in tester time. In addition, it allows for the use of public key cryptography by the use of dedicated keys for signing and encryption without the overhead typically associated with these approaches. Lastly, it allows for simple and secure provider deployment, removing the need to manage sensitive symmetric key material or to explicitly authenticate the public key provided by each device.

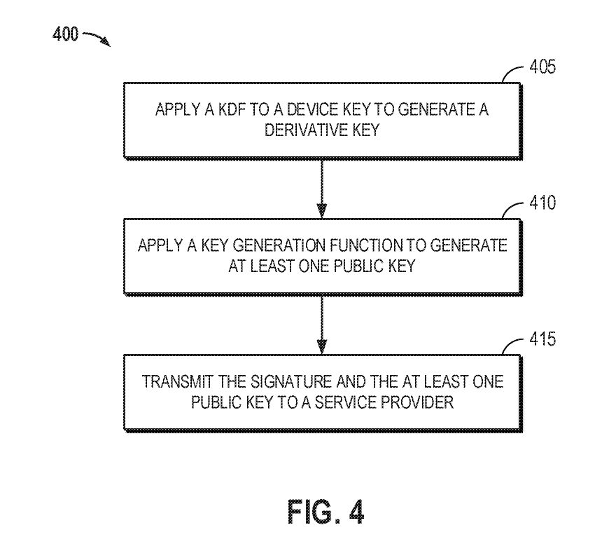

With brief reference to FIG. 4, FIG. 4 is flow diagram illustrating a process 400 implemented by a computing device. For example, at block 405, a KDF may be applied to a device key to generate a derivative key. At block 410, a key generation function may be applied to the derivative key to generate at least one public key. Lastly, at block 415, the signature and the at least one public key may be transmitted through an interface to a service provider such that the service provider is capable of verifying the computing device to establish a secure communication channel.

It should be appreciated that aspects of the previously described processes may be implemented in conjunction with the execution of instructions by a processor (e.g., processors 102, 152, 162) of devices (e.g., computing device 100, chip vendor 150, service provider 160), as previously described. Particularly, circuitry of the devices, including but not limited to processors, may operate under the control of a program, routine, or the execution of instructions to execute methods or processes in accordance with embodiments described (e.g., the processes and functions of FIGS. 2-4). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
a non-volatile storage medium (NVM) to store a signature and a device key, the device key based on a symmetric master key and an identifier;
an interface; and
a processor coupled to the interface and the NVM, the processor configured to:
apply a key derivation function (KDF) to the device key to generate a derivative key;
apply a key generation function to the derivative key to generate at least one public key; and
command transmission of the signature and the at least one public key through the interface to a service provider.

2. The computing device of claim 1, wherein the key generation function to generate the at least one public key includes an elliptic curve function.

3. The computing device of claim 2, wherein the processor is further configured to encrypt a pair of predefined numbers to generate a pair of ciphertext values that are used as seed inputs to the elliptic curve function.

4. The computing device of claim 2, further comprising generating a pair of public keys by the elliptic curve function including an authentication public key and an encryption public key.

5. The computing device of claim 4, wherein the authentication public key and the encryption public key are unique to the computing device.

6. The computing device of claim 5, wherein the processor is further configured to receive encrypted data from the service provider using the public keys.

7. The computing device of claim 4, wherein the interface is a wireless interface and the signature and the public keys are transmitted wirelessly through the wireless interface to the service provider.

8. The computing device of claim 1, wherein the NVM to store the signature and the device key comprises a fuse-based one time programmable (OTP) memory.

9. A method comprising:
storing a signature and a device key in a non-volatile storage medium (NVM), the device key based on a symmetric master key and an identifier;
applying a key derivation function (KDF) to the device key to generate a derivative key;
applying a key generation function to the derivative key to generate at least one public key; and
commanding transmission of the signature and the at least one public key through an interface to a service provider.

10. The method of claim 9, wherein the key generation function to generate the at least one public key includes an elliptic curve function.

11. The method of claim 10, further comprising encrypting a pair of predefined numbers to generate a pair of ciphertext values that are used as seed inputs to the elliptic curve function.

12. The method of claim 10, wherein the elliptic curve function generates a pair of public keys including an authentication public key and an encryption public key.

13. The method of claim 12, wherein the authentication public key and the encryption public key are unique to the computing device.

14. The method of claim 13, further comprising receiving encrypted data from the service provider using the public keys.

15. The method of claim 12, wherein the interface is a wireless interface and the signature and the pair of public keys are transmitted wirelessly through the wireless interface to the service provider.

16. The method of claim 9, wherein the NVM to store the signature and the device key comprises a fuse-based one time programmable (OTP) memory.

17. A non-transitory computer-readable medium including code that, when executed by a processor of a computing device, causes the processor to:
apply a key derivation function (KDF) to a device key stored in a non-volatile storage medium (NVM) to generate a derivative key, the device key based on a symmetric master key and an identifier;
apply a key generation function to the derivative key to generate at least one public key; and
command transmission of a signature stored in the NVM and the at least one public key through an interface to a service provider.

18. The computer-readable medium 17, wherein the key generation function to generate the at least one public key includes an elliptic curve function.

19. The computer-readable medium 18, further comprising code to encrypt a pair of predefined numbers to generate a pair of ciphertext values that are used as seed inputs to the elliptic curve function.

20. The computer-readable medium 18, further comprising code to generate a pair of public keys by the elliptic curve function including an authentication public key and an encryption public key.

21. The computer-readable medium 20, wherein the authentication public key and the encryption public key are unique to the computing device.

22. The computer-readable medium 21, further comprising receiving encrypted data from the service provider using the public keys.

23. The computer-readable medium 20, wherein the interface is a wireless interface and the signature and the pair of public keys are transmitted wirelessly through the wireless interface to the service provider.

24. The computer-readable medium 17, wherein the NVM to store the signature and the device key comprises a fuse-based one time programmable (OTP) memory.

25. A computing device comprising:
means for storing a signature and a device key, the device key based on a symmetric master key and an identifier;
means for applying a key derivation function (KDF) to the device key to generate a derivative key;
means for applying a key generation function to the derivative key to generate a at least one public key; and
means for commanding transmission of the signature and the at least one public key to a service provider.

26. The computing device of claim 25, wherein the key generation function to generate the at least one public key includes an elliptic curve function.

27. The computing device of claim 26, further comprising means for encrypting a pair of predefined numbers to generate a pair of ciphertext values that are used as seed inputs to the elliptic curve function.

28. The computing device of claim 27, further comprising means for generating a pair of public keys by the elliptic curve function including an authentication public key and an encryption public key

29. The computing device of claim 28, wherein the authentication public key and the encryption public key are unique to the computing device.
